(19) United States
(12) Patent Application Publication
(10) Pub. No.: US 2011/0312414 A1
(43) Pub. Date: Dec. 22, 2011

(54) AUTOMATED CERTIFICATION OF VIDEO GAME ADVERTISING USING OCR

(75) Inventor: FRANCIS O'DONNELL, New York City, NY (US)

(73) Assignee: MICROSOFT CORPORATION, REDMOND, WA (US)

(21) Appl. No.: 12/816,930

(22) Filed: Jun. 16, 2010

(51) Int. Cl. G06F 17/00

(52) U.S. Cl. 463/31; 463/43

(57) ABSTRACT

Methods and computer-storage media having computer-executable instructions embodied thereon that facilitate generating an analysis or certification of inventory elements in a virtual environment, such as a 3-D video game environment, are provided. Data is referenced from a video game, including the identity of each inventory element in the video game environment where an advertisement may be displayed. Inventory elements are populated with test patterns corresponding to the identity of the inventory elements. Screenshots are referenced from each of the inventory elements in the video game and, based on those screenshots, identifiable features are associated with each of the inventory elements using optical character recognition. Based on the identified features associated with each of the inventory elements, an analysis is automatically generated for each of the inventory elements in the video game environment. A report may be generated based on the analysis of the inventory elements.

### BACKGROUND

Advertisements are often displayed in the context of video games. A static advertisement, permanently placed into a video game environment, is of decreasing value to the advertiser who, over time, may wish to invest in new or different games. Further, such static advertisements are quickly outdated, as products change and new campaigns are launched. By offering the use of dynamic advertisements that are temporary and capable of being changed, video games display real-time advertisements in the context of the video game experience. This experience is not only more meaningful to the advertiser, but is also customizable to the intended audience.

In some instances, dynamic advertisements are displayed in three-dimensional (3-D) video games. Game developers may establish, as a part of programming a 3-D video game, several locations throughout the game where dynamic advertising will be placed during real-time operation. As advertisements are displayed in the context of a live, 3-D gaming environment, it is important to verify and/or certify that such advertisements are presented accurately and as intended. Despite the advantages that exist for the placement of dynamic advertisements in 3-D video games, improvements may still be made, such as, for instance, in certifying the correct placement of such dynamic advertisements in a 3-D video game environment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to certifying and/or analyzing advertisements in a virtual environment, such as a video game environment. In embodiments, the video game environment is a 3-D video game environment. Data is referenced from the video game environment, which may include data relating to the identity and location of inventory elements in the video game environment. An inventory element refers to an advertising placement in the video game environment where an advertisement will be displayed during real-time, playing of a video game. The identity of an inventory element may include a name or unique identifier associated with the inventory element. Further, the location of the inventory element may include the three-dimensional coordinates of the inventory element in the video game environment. During certification, or testing/analysis, of a video game, each of the inventory elements is populated with a test pattern. Test patterns may include one or more of a name, a unique identifier, a “TOPLEFT” keyword, a “TOPRIGHT” keyword, a “BOTTOMLEFT” keyword, a “BOTTOMRIGHT” keyword, a color indicator, a shading gradient indicator, or any number of identifiable features. In embodiments, each test pattern is specific to the individual inventory element it populates.

Screenshots are referenced from each of the inventory elements in the video game environment. Such screenshots may be acquired by automatically changing the viewpoint of the camera in the video game to the location of each of the inventory elements in the video game environment. In some instances, a screenshot may be edited to remove arbitrary content outside the perimeter of the test pattern populating the inventory element. Based on the screenshots of each inventory element, features associated with each inventory element are identified. Such identifiable features, as derived from the test pattern populating the inventory element, may include a name, a unique identifier, a “TOPLEFT” keyword, a “TOPRIGHT” keyword, a “BOTTOMLEFT” keyword, a “BOTTOMRIGHT” keyword, a color indicator, and a shading gradient indicator. These features are identified using an optical character recognition (OCR) tool. In some instances, the identified features are used to generate a list of features, for use in analyzing the inventory elements.

Having identified one or more features associated with each of the inventory elements in the video game environment, an analysis is automatically generated. The analysis may include evaluating, for each inventory element, whether a unique identifier is present; whether a border may be derived utilizing the “TOPLEFT” keyword, “TOPRIGHT” keyword, “BOTTOMLEFT” keyword, and “BOTTOMRIGHT” keyword; whether an inventory element is occluded, inverted, or stretched; and whether each of the inventory elements “passed” or “failed” the analysis. Based on the automatically-generated analysis, a report may also be generated that summarizes the results of the certification of the video game.

### BRIEF DESCRIPTION OF THE DRAWINGS

The present invention is described in detail below with reference to the attached drawing figures, wherein:

FIG. 1 a block diagram of an exemplary computing environment suitable for use in implementing embodiments of the present invention;

FIGS. 2-3 are flow diagrams showing methods for analyzing inventory elements in a video game environment, in accordance with embodiments of the present invention;

FIG. 4 is an illustrative display of a test pattern used to analyze inventory elements in a video game environment, in accordance with an embodiment of the present invention; and

FIGS. 5-7 are exemplary displays of screenshots of test patterns populating inventory elements in a video game environment, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to automatically generating an analysis, or certification, of advertisements in a virtual environment, such as a video game environment. More particularly, the proper placement of dynamic advertising in a 3-D video game environment is analyzed. In embodiments, advertisements in a video game environment may be an image advertisement, a textual advertisement, a video advertisement, or a combination thereof. Such advertisements may also be referred to as “inventory elements,” “display advertisements,” or “ad placements.” In some embodiments, inventory elements may be displayed in “virtual worlds” or “virtual environments” other than, or in addition to, a video game environment.

In embodiments, an inventory element is rectangular in shape, and may be populated with any number of different advertisements streamed into the video game environment during live operation by a user, or any number of different test patterns streamed into the game environment during game certification, or testing of the game. As used herein, “populating,” “streaming,” and “serving” refers to the directed presentation of an image advertisement, a video advertisement, or a test pattern into a specified location, such as, for example, the directed presentation of a test pattern into an inventory element. While a game is being tested, to analyze or certify that the content being streamed into each inventory element is displayed correctly, test patterns are populated (or streamed/served) into each of the inventory elements. As will be understood by one of ordinary skill in the art, during live operation of a video game, individual advertisements are populated into each of the inventory elements, rather than test patterns.

Test patterns being streamed into a video game environment during testing, which populate inventory elements in a video game environment, are used to automatically generate an analysis of each of the inventory elements in the video game environment. Features of the test patterns are identified from screenshots of the inventory elements using an OCR tool. Such features may include, by way of example only, a name, a unique identifier, a zone name, a “TOPLEFT” keyword, a “TOPRIGHT” keyword, a “BOTTOMLEFT” keyword, a “BOTTOMRIGHT” keyword, a color indicator, and a shading gradient indicator. An analysis is automatically generated based on the identified features of each of the inventory elements. Such analysis may include, by way of example only, a determination of whether the identified features are present in the screenshot of the inventory element; whether an inventory element is occluded, inverted, or stretched; whether color and shading are accurately presented in the inventory element; and whether an inventory element “passed” or “failed” the analysis. Based on the automatically-generated analysis, a report may also be generated that summarizes the results of the analysis of the inventory elements in the video game environment.

Accordingly, one embodiment of the present invention is directed to one or more computer-readable media storing computer-useable instructions that, when used by one or more computing devices, causes the one or more computing devices to perform a method of analyzing inventory elements in a video game environment. The method includes referencing data from a video game environment, wherein the data includes the identity of each of one or more inventory elements in the video game environment; populating each of the one or more inventory elements with a test pattern, wherein each test pattern corresponds to the identity of each of the one or more inventory elements being populated; referencing screenshots of each of the one or more inventory elements in the video game environment; based on the screenshots of each of the one or more inventory elements, identifying features associated with each of the one or more inventory elements; and based on the identified features associated with each of the one or more inventory elements, automatically generating an analysis of each of the one or more inventory elements in the video game environment.

In another embodiment, the invention is directed to a method performed by one or more server devices for analyzing one or more inventory elements in a video game environment. The method includes receiving an identity and location of each of one or more inventory elements in the video game environment; populating each of the one or more inventory elements in the video game environment with a test pattern, wherein each test pattern corresponds to the identity and location of each of the one or more inventory elements; receiving screenshots of each of the one or more inventory elements in the video game environment; based on the screenshots of each of the one or more inventory elements, identifying features associated with each of the one or more inventory elements; and based on the identified features associated with each of the one or more inventory elements, automatically generating an analysis of each of the one or more inventory elements in the video game environment.

A further embodiment of the present invention is directed to one or more computer-readable media storing computer-useable instructions that, when used by one or more computing devices, causes the one or more computing devices to perform a method for analyzing inventory elements in a three-dimensional video game environment. The method includes referencing an identity and a location of each of one or more inventory elements in the three-dimensional video game environment, wherein an identity of each of the one or more inventory elements includes at least one of a name and a unique identifier, and further wherein the location of each of the one or more inventory elements includes three-dimensional coordinates of each of the one or more inventory elements in the video game environment; populating each of the one or more inventory elements in the video game environment with a respective test pattern, wherein each respective test pattern corresponds to the identity and location of each of the one or more inventory elements; referencing screenshots of each of the one or more inventory elements in the video game environment, wherein each screenshot was acquired by automatically changing a respective viewpoint of a camera to the location of each of the one or more inventory elements in the video game environment; editing each respective screenshot to eliminate content outside a perimeter of the test pattern populating each of the one or more inventory elements; based on the respective screenshot of each of the one or more inventory elements, identifying one or more features associated with each of the one or more inventory elements using an OCR tool, wherein identifying one or more features associated with each of the one or more inventory elements comprises identifying one or more of a name, a unique identifier, a “TOPLEFT” keyword, a “TOPRIGHT” keyword, a “BOTTOMLEFT” keyword, a “BOTTOMRIGHT” keyword, a color indicator, and a shading gradient indicator; based on the identified one or more features associated with each of the one or more inventory elements, automatically generating an analysis of each of the one or more inventory elements in the video game environment, wherein the analysis comprises one or more of 1) determining whether a unique identifier is present, 2) deriving a border utilizing the “TOPLEFT” keyword, “TOPRIGHT” keyword, “BOTTOMLEFT” keyword, and “BOTTOMRIGHT” keyword, 3) determining whether any of the one or more inventory elements are at least partially occluded, 4) determining whether any of the one or more inventory elements are at least partially inverted, 5) determining whether any of the one or more inventory elements are at least partially stretched, 6) determining whether colors are displayed correctly in any of the one or more inventory elements, and 7) determining whether shading is displayed correctly in any of the one or more inventory elements; and determining whether each of the one or more inventory elements “passed” or “failed” the analysis.

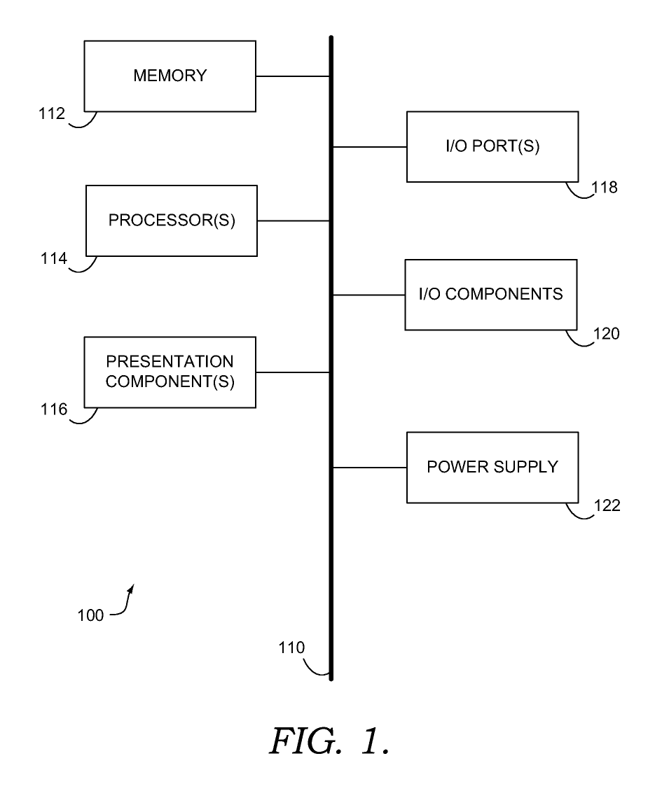

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventor recognizes that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media accessible by the computing device 100 and includes both volatile and nonvolatile media, and removable and non-removable media, implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

As indicated previously, embodiments of the present invention are directed to automatically analyzing, or testing/certifying, inventory elements in a video game environment. A video game, or video game environment, may include a single or multiple inventory elements for displaying advertisements to a user. As will be understood, the terms “video game” and “video game environment” may be used interchangeably to refer to the environment where an inventory element displays advertisements, or test patterns, within the 3-D environment of a video game.

In embodiments, each inventory element in a video game is unique, with separately identifiable characteristics such that a particular advertisement or a particular test pattern can be directed to be displayed in association with a particular inventory element. Such identifiable characteristics may include, by way of example only, a name, a unique identifier, or any number of other identifying characteristics particular to the individual inventory element. For example, inventory element number “123456” may be populated with an advertisement that is directed to be displayed in inventory element number “123456.” Similarly, a test pattern with the unique identifier “123456” may be directed to be displayed in inventory element number “123456.”

In addition to the unique identity associated with each inventory element, each inventory element may also be associated with particular location information. Such information may include the 3-D coordinates of the inventory element in a video game environment. In embodiments, the 3-D coordinates of an inventory element identify not only where the inventory element was initially positioned by the programmer of the video game, but also where a test pattern is expected to be displayed during certification of a game, or where an advertisement is expected to be displayed during real-time game play.

During testing of a video game, identifying information and/or location information are referenced, or received, for each of the inventory elements in the video game. As used herein, referencing refers to the accessing, retrieving, receiving, obtaining, and/or downloading of data. Referencing may occur automatically, or in response to a request, such as a request from a Game Certification Tool that is conducting the automatic analysis of a video game. Additionally, testing of a video game may also be referred to as certifying, certification, analyzing, or analysis of a video game, or of inventory elements in a video game environment.

Based on the referenced identity and/or location of inventory elements in the video game environment, test patterns are populated in each of the inventory elements of the video game environment. In embodiments, a test pattern includes identifying information that can be detected by an OCR tool. Additionally, in some embodiments, a test pattern is rectangular in shape. By way of example only, and not limitation, a test pattern may include letters and/or words, such as the name of the test pattern, a unique identifier of the test pattern, and particular keywords such as “TOPLEFT,” “TOPRIGHT,” “BOTTOMLEFT,” and “BOTTOMRIGHT,” that may be positioned in the corresponding corners of the (rectangular) test pattern. It should be understood that a number of letters, symbols, or other indicators of the top left, top right, bottom left, and bottom right portions of a test pattern may be used in place of or in addition to the keywords “TOPLEFT,” “TOPRIGHT,” “BOTTOMLEFT,” and “BOTTOMRIGHT.” A test pattern may also include the dimensions of the test pattern, the name of the inventory element where the test pattern will be displayed, the name of a game level, or “zone,” in the game where the inventory element occurs, a shading gradient indicator, a color indicator, and any number of other identifiable features.

In embodiments, each test pattern is unique to the inventory element that it populates. For example, as previously discussed, test pattern number “123456” may be specific to inventory element “123456.” As will be understood, any number of identifying characteristics of a particular test pattern may be coordinated with the particular inventory element that the test pattern is intended to populate. Further, such characteristics may be detectable by an OCR tool.

Screenshots are referenced, or received, from each of the inventory elements in the video game environment. A screenshot refers to an image automatically obtained by the camera of a video game by changing the viewpoint of the camera, or “navigating,” to the location of each of the inventory elements in the 3-D video game environment. Such navigation is possible by virtue of the referenced information regarding the location of each of the inventory elements. In embodiments, having been populated with test patterns during certification, screenshots of inventory elements depict the particular test pattern that was directed for placement in each of the particular inventory elements. In further embodiments, a screenshot of a location in the video game environment is edited to remove content outside the perimeter of the test pattern that is populating the inventory element. Such content may be referred to as “arbitrary” content, as it is outside the intended viewing area of the test pattern. Editing the screenshot may also be referred to as “clipping” the screenshot, so that content outside the perimeter of the test pattern is removed.

The perimeter of the test pattern may be determined using the three-dimensional coordinates of the inventory element, and the known proportions of the test pattern populating the particular inventory element. For example, the perimeter may be determined based on the positions of the keywords “TOPLEFT,” “TOPRIGHT,” “BOTTOMLEFT,” and “BOTTOMRIGHT,” in the screenshot, as compared to the expected 3-D coordinates of the inventory element populated by a test pattern. In embodiments, identifying these keywords using the OCR tool provides the correct coordinates of the test pattern for editing, or clipping, a screenshot of an inventory element. In further embodiments, as will be explained in further detail below, the keywords defining the perimeter of a test pattern may be used when generating an analysis of whether the test pattern is displayed correctly in a particular inventory element.

Identifiable features associated with each of the inventory elements are determined based on the screenshots. In embodiments, an OCR tool is used to determine which identifiable features are detected in each of the screenshots. For example, a screenshot of inventory element “123456” may depict, as intended, a test pattern with the unique identifier “123456,” which the OCR tool can detect. Any number of identifiable features may be detected by the OCR tool based on screenshots of the inventory elements, such as, for example, a name, a unique identifier, a “TOPLEFT” keyword, a “TOPRIGHT” keyword, a “BOTTOMLEFT” keyword, a “BOTTOMRIGHT” keyword, a shading gradient indicator, and a color indicator. As previously discussed, in some embodiments, the OCR tool may detect the name, unique identifier, and keywords of the test pattern, for later analysis of whether such features are present. In further embodiments, the OCR tool may also detect the shading gradient indicator and the color indicator for later analysis of whether such shading and colors are depicted correctly in the inventory element. In some instances, a list is generated which identifies the features detected by the OCR tool for each inventory element.

Based on the identified features associated with each of the inventory elements, an analysis is automatically generated for each inventory element in the video game environment. Such an analysis may include the determination of whether a name or unique identifier is present in a screenshot depicting the test pattern that is populating a particular inventory element. By verifying the presence of the name or unique identifier of the expected test pattern, the analysis determines whether the correct test pattern is displayed in the intended inventory element. In some embodiments, if the analysis determines that the incorrect test pattern is being displayed in an inventory element, the inventory element will “fail” the automatic analysis.

In embodiments, the analysis automatically generated for each inventory element may determine, based on keywords, whether an inventory element is correctly populated by its respective test pattern. Such an analysis may utilize the position of the detected keywords “TOPLEFT,” “TOPRIGHT,” “BOTTOMLEFT,” and “BOTTOMRIGHT,” as determined by the OCR tool. Based on the location of the detected keywords “TOPLEFT,” “TOPRIGHT,” “BOTTOMLEFT,” and “BOTTOMRIGHT,” in relation to the expected 3-D coordinates of the corners of the particular inventory element, a determination may be made as to whether or not the test pattern is displayed correctly. In embodiments, the analysis may determine that the test pattern is being stretched when displayed in a particular inventory element, based on the positions of the detected keywords. For example, if the “TOPLEFT” and “TOPRIGHT” corners of a test pattern are found outside the 3-D coordinates of the top corners of an inventory element, the test pattern is determined to be stretched outside the expected area of the inventory element. In some embodiments, the analysis may determine that a test pattern is stretched by virtue of the dimensions of the test pattern that are displayed on the test pattern, and detected by the OCR tool.

Any number of different determinations may be made based on the location, and proportion, of the keywords “TOPLEFT,” “TOPRIGHT,” “BOTTOMLEFT,” and “BOTTOMRIGHT,” such as, for instance, determining whether the test pattern is inverted or rotated. For example, if the keyword “TOPLEFT” is viewed upside down and in the bottom, left corner of the inventory element, then the analysis may determine that the test pattern is displaying upside-down, or in an inverted position. As such, although the correct test pattern may be displayed in a particular location, the test pattern may nonetheless be oriented incorrectly in the intended inventory element. In embodiments, this inverted display may be further characterized as “failing” the analysis.

In further embodiments, during the analysis based on identified features, a determination is made of whether an inventory element is wholly or partially occluded. An occluded, or blocked, inventory element refers to an inventory element that is obstructed from view by a user of a video game. Such obstruction may occur, for example, because of other characters in the 3-D video game environment. In embodiments, the analysis determines that one or more identifiable features of a test pattern were not able to be viewed by the OCR tool. For instance, the OCR tool may not detect the term “BOTTOMLEFT” because it is partially obstructed by a character in the 3-D video game environment. Similarly, when none of the identifiable features of the test pattern displayed in an inventory element are able to be detected using the OCR tool, the analysis determines that the particular inventory element in the video game is occluded. In embodiments, an occluded test pattern may be further characterized as a “failed” analysis.

In further embodiments, the identified features associated with an inventory element may include a color indictor and/or a shading gradient indicator. Based on detection by the OCR tool, such indicators may be displayed correctly, or incorrectly, in the inventory element populated by the test pattern. For example, a color indicator may be displayed in an inventory element, as depicted in the screenshot of the test pattern populating the inventory element. The test pattern populating an inventory element may be accurately representing a color indicator including sample colors, such as, for example, the colors red, green and blue. Having correctly displayed a color indicator that includes red, green and blue, the inventory element may be characterized as having “passed” the analysis for color. Similarly, a test pattern that includes a shading gradient indicator may be accurately displayed in an inventory element, and therefore be characterized as having “passed” the analysis for shading. In embodiments, both color indicators and shading gradient indicators in test patterns are used to determine, during real-time dynamic advertising, how accurately the colors and shading of advertisements populating the inventory elements will be displayed.

In some embodiments, as previously discussed, a determination is made whether an inventory element has “passed” or “failed” the analysis. What is meant by “passing” or “failing” the analysis may be based off of any number of different elements of the analysis of an inventory element. More specifically, the analysis may determine that an inventory element populated by a test pattern has failed the analysis because of one or more incorrectly displayed features of the test pattern. For example, any number of identified features, or features that were not able to be identified by the OCR tool, may be used to determine whether an inventory element “passed” or “failed” the analysis. By way of example only, and not limitation, the OCR tool may detect the incorrect unique identifier for the particular test pattern populating a particular inventory element. This may indicate a “failing” result because the incorrect test pattern is being displayed in that particular inventory element. In other embodiments, a “failing” result may be indicated when the analysis determines that an inventory element is stretched, inverted, occluded, and the like. Based on any number of identified features that are expected to be detected by the OCR tool in the test pattern that is populating an inventory element, the analysis may generate a passing or failing determination. The determination may be based on a single feature or multiple features identified in the inventory element. As such, a test pattern that has either “passed” or “failed” the analysis may also be used to predict whether a real-time dynamic advertisement would also display correctly or incorrectly.

A report may be generated that summarizes the findings of the analysis. In embodiments, a report is generated automatically, after the automatic analysis of inventory elements in the video game. The report may be presented to a user for viewing, or stored in a database of reports for later access.

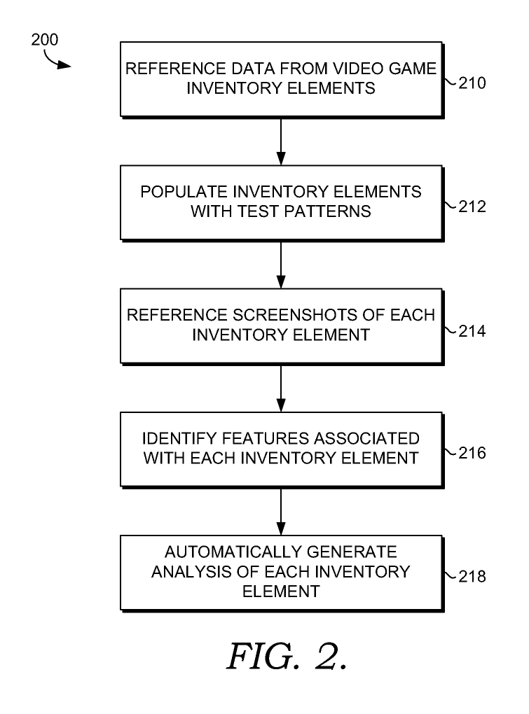

Referring now to FIG. 2, a flow diagram is provided illustrating an exemplary method 200 for analyzing inventory elements in a video game. As shown at block 210, data is referenced from video game inventory elements. As previously discussed, such data may include the identity and location of inventory elements in a video game environment. The identity of an inventory element may include a unique identifier, or a name, of the particular inventory element. A location of an inventory element may include the three-dimensional coordinates of the inventory element in the video game environment. Additional identifying information may be included in the data relating to each of the inventory elements in a video game environment.

At block 212, inventory elements are populated with test patterns. Such test patterns are particular to the specific inventory element being populated. For example, inventory element number “1” is populated with test pattern “1.” A test pattern may include any number of different identifiable features that can be detected by an OCR tool.

As shown at block 214, screenshots are referenced of each inventory element in the video game. Such screenshots are obtained by automatically changing the viewpoint of the camera in the video game to the location of each of the inventory elements in the video game environment. In embodiments, the screenshots may be edited to remove content outside the perimeter of the test pattern populating the inventory element.

At block 216, features associated with each inventory element are identified. Such identified features may include, but are not limited to, a name, a unique identifier, a “TOPLEFT” keyword, a “TOPRIGHT” keyword, a “BOTTOMLEFT” keyword, a “BOTTOMRIGHT” keyword, a shading gradient indicator, a color indicator, and the like. Such identified features are determined based on screenshots of the inventory elements, which are populated by test patterns.

As shown at block 218, an analysis is automatically generated for each inventory element. The analysis may include an evaluation of whether a unique identifier is present in the identified features from the screenshot of the inventory element. Further, the analysis may derive a border of as test pattern in an inventory element using the “TOPLEFT” keyword, “TOPRIGHT” keyword, “BOTTOMLEFT” keyword, and “BOTTOMRIGHT” keyword. Using this border, or using separate or additional features, the analysis may also determine whether an inventory element is wholly or partially occluded, inverted, and/or stretched. In further embodiments, the analysis automatically generated for each inventory element may also determine whether the particular inventory element “passes” or “fails” the analysis.

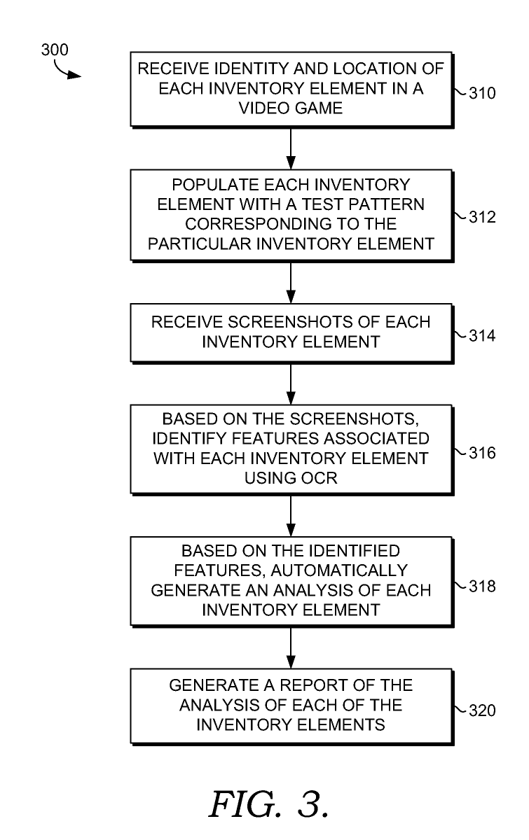

Turning now to FIG. 3, a flow diagram is provided that illustrates a method 300 for certifying advertisements in a video game. As shown at block 310, the identity and location of each inventory element in a video game is received. Based on this information, as shown at block 312, each inventory element is populated with a test pattern corresponding to the particular inventory element. At block 314, screenshots of each inventory element are received. Receiving such screenshots may also include editing, or “clipping,” the screenshot images to display only the test pattern populating the inventory element. At block 316, based on the screenshots, features associated with each inventory element are identified using an OCR tool. In embodiments, features associated with the test pattern populating the inventory element are detected by the OCR tool and used to populate a list of identified features for each inventory element.

As shown at block 318, based on the identified features, an analysis of each inventory element is automatically generated. Such an analysis may include an evaluation of whether the test pattern displayed in an inventory element is wholly or partially stretched, occluded, and/or inverted. Still further, the analysis may determine whether the correct test pattern is being displayed by the correct inventory element, such as, for example, by verifying whether the correct unique identifier was detected by the OCR tool. In embodiments, as part of the analysis, a border may be derived for the test pattern in an inventory element, utilizing the “TOPLEFT” keyword, “TOPRIGHT” keyword, “BOTTOMLEFT” keyword, and “BOTTOMRIGHT” keyword identified by the OCR tool. At block 320, a report of the analysis of each of the inventory elements is generated.

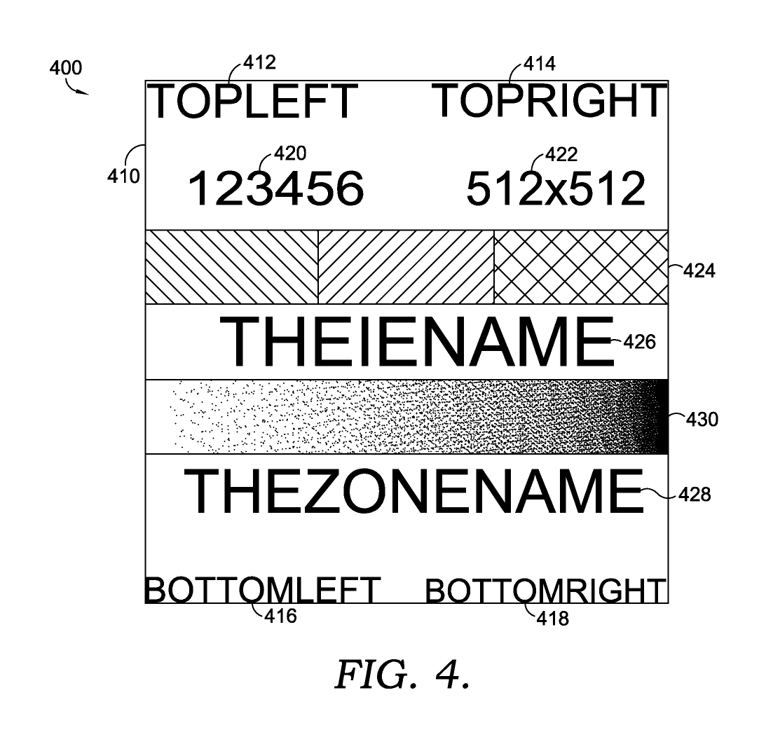

Referring next to FIG. 4, an illustrative test pattern 400 used to certify advertisements in a video game environment is shown. It should be understood that the test pattern 400 is only one embodiment of an exemplary test pattern used to certify, or analyze, inventory elements in a video game environment. The perimeter 410 of the test pattern 400 is generally defined by a straight line. The test pattern 400 is generally rectangular in shape, and in some embodiments, may be in the shape of a square. Any number of identifiable features may be included inside the perimeter 410 of the test pattern 400. As shown, test pattern 400 includes keyword “TOPLEFT” 412, keyword “TOPRIGHT” 414, keyword “BOTTOMLEFT” 416, and keyword “BOTTOMRIGHT” 418. Keywords 412, 414, 416, and 418 may be used to derive a perimeter of the test pattern 400 using OCR. In embodiments, keywords 412, 414, 416, and 418 may be used to determine the size of a test pattern that is populating an inventory element. In further embodiments, keywords 412, 414, 416, and 418 in the test pattern 400 are depicted in all-capital letters, so that they may be easily detected by the OCR tool.

Test pattern 400 also includes a unique identifier 420 of the number “123456,” and dimensions 422 of “512×512.” The dimensions 422 of a test pattern 400 may be indicated using any number of dimensions and/or measurements, such as, for example, by noting that the test pattern is “512” pixels high, and “512” pixels wide. In embodiments, the dimensions 422 of the test pattern 400 are used to determine whether a test pattern 400 is stretched when displayed in an inventory element. A color indicator 424 is shown displayed across the test pattern 400. The color indicator 424 may represent any number of colors recognizable by the OCR tool. For example, color indicator 424 may represent red, green and blue sections of color that can be detected by the OCR for analysis of whether such colors are displayed correctly when populating an inventory element.

Test pattern 400 further includes the inventory element name 426 and zone name 428. The zone name 428 is the name of the level, or “zone,” where an inventory element is displayed in a virtual environment. By way of example only, a baseball video game might have a level called “YankeesStadium,” and a test pattern 400 displayed in that level of the video game may include the zone name 420 of “YANKEESSTADIUM.” In embodiments, letters or words included in the test pattern 400, such as the inventory element name 426 and the zone name 428, are depicted in all-capital lettering, so that the features may be easily identified by the OCR tool. Inventory element name 426 indicates which particular inventory element is intended to be populated with test pattern 400. Using OCR, and based on recognition of identifiable features in the screenshot of test pattern 400, an analysis can determine whether the inventory element associated with the inventory element name 426 is correctly populated by test pattern 400, with a particular unique identifier 420.

Test pattern 400 also includes shading gradient indicator 430. The shading gradient indicator 430 may be utilized to determine whether an inventory element displaying test pattern 400 is correctly displaying shading or various different shades of black and white. In some embodiments, when evaluating a screenshot of test pattern 400 populating a particular inventory element, a determination may be made whether the shading gradient indicator 430 is accurately displayed. For example, if the shading gradient indicator 430 is fully darkened, or undetectable by the OCR, the shading may “fail” the analysis.

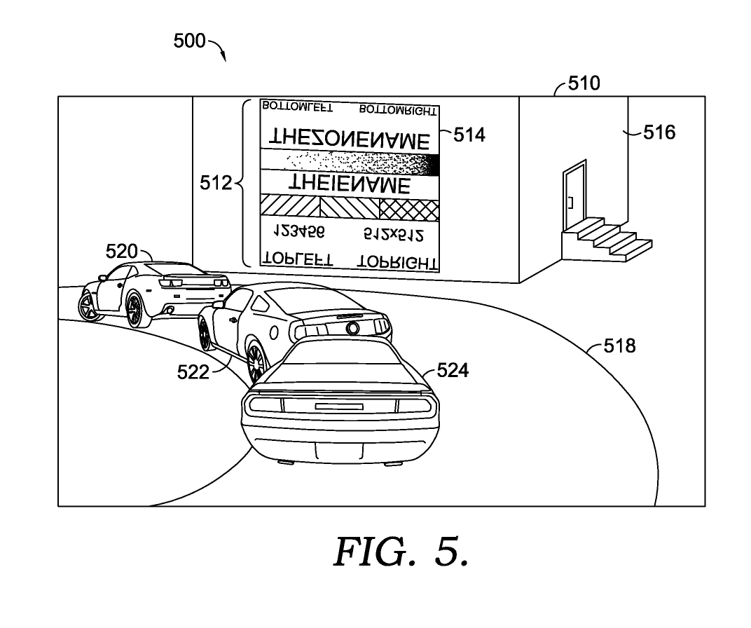

With reference now to FIGS. 5-7, exemplary displays of test patterns populating inventory elements in a video game environment are shown. Referring initially to FIG. 5, a display 500 generally depicts a screenshot 510. As shown in the screenshot 510, an inventory element 512 is populated by a test pattern 514 on the side of a building 516. The building 516 is positioned alongside a racetrack 518, with three racecars 520, 522, and 524 driving on the racetrack 518. The inventory element 512 is displaying the test pattern 514 in an inverted position, such that the wording on the test pattern 514 is upside-down and reversed. In embodiments, the screenshot 510 is edited to eliminate the content surrounding the perimeter of the inventory element 512, such that only the test pattern 514 may be viewed in the screenshot 510. For example, the building 516, racetrack 518, and racecars 520, 522, and 524 may be edited, or “clipped,” from the screenshot 510. In embodiments, the inventory element 512 would “fail” an automated analysis because any real-time advertisement placed into the inventory element 512 during dynamic advertising would also be displayed upside-down, or in an inverted position. In other words, the inventory element 512, by virtue of the incorrect presentation of the test pattern 514, “fails” certification.

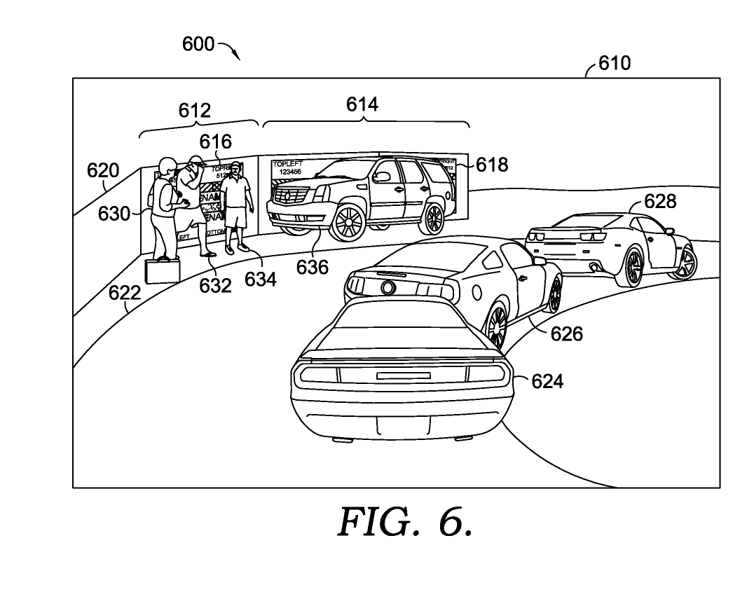

Referring next to FIG. 6, a display 600 generally depicts a screenshot 610. As shown in the screenshot 610, inventory elements 612 and 614 are populated by test patterns 616 and 618 along the side of a wall 620. The wall 620 is positioned alongside a racetrack 622, with three racecars 624, 626, and 628 driving on the racetrack 622. The inventory element 612 is displaying a test pattern 616 in an occluded position, such that the wording on the test pattern 616 is partially obstructed from view. The inventory element 614 is displaying the test pattern 618 in both an occluded and stretched position, as it is obstructed from view and stretched beyond its intended dimensions. In embodiments, the screenshot 610 may be edited to eliminate the content surrounding the perimeter of the inventory element 612, such that only the test pattern 616 may be viewed in the screenshot 610. Additionally, a separate screenshot 610 may be generated and edited to eliminate the content surrounding the perimeter of the inventory element 614, such that only the test pattern 618 may be viewed in an additional screenshot 610. As will be understood, editing the screenshot 610 to remove content surrounding the perimeter of inventory element 612 or inventory element 614 does not remove from the screenshot the portion of the persons 630, 632, and 634, or the portion of the vehicle 636, that are obstructing the inventory elements 612 and 614. As such, an analysis of the screenshot 610 of the inventory element 612 will remain obstructed, even after editing, by the persons 630, 632, and 634. Similarly, after editing the screenshot of the inventory element 614, the vehicle 636 will still obstruct the test pattern 618 from full view. In embodiments, the placements of the test patterns 616 and 618 would generate a “failing” result of an analysis of the inventory elements 612 and 614, because both test patterns are obstructed from view of the video game player. More specifically, in some embodiments, the OCR tool would either partially or completely fail an analysis of inventory elements 612 and 614, which would consequently produce a “failing” result. During live, real-time play of a video game depicting the illustrated display 600, advertisements populating the inventory elements 612 and 614 would not be visible.

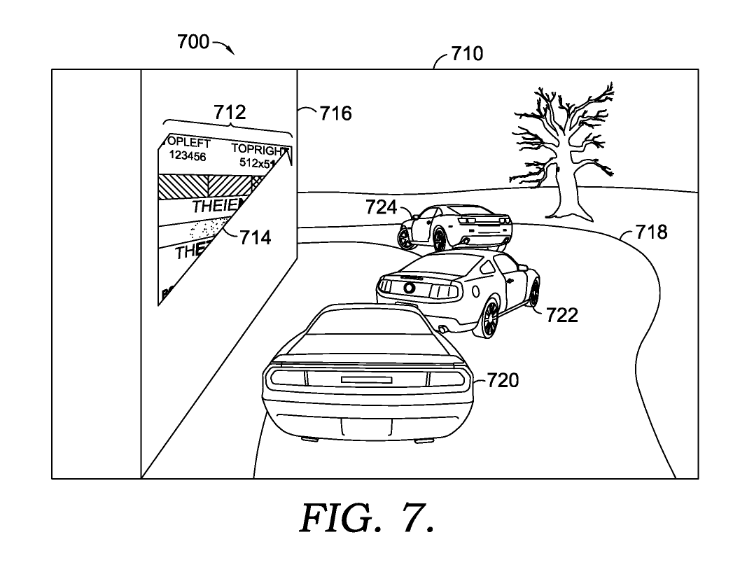

Turning now to FIG. 7, a display 700 generally depicts a screenshot 710. As shown in the screenshot 710, an inventory element 712 is populated by a test pattern 714 on the side of a wall 716. The wall 716 is positioned alongside a racetrack 718, with three racecars 720, 722, and 724 driving on the racetrack 718. An inventory element 712 is displaying the test pattern 714 in an occluded position, such that the wording on the test pattern 714 is partially obstructed, or occluded, from view. In embodiments, the test pattern 714 would “fail” an analysis of the inventory element 712 because any advertisement populating the inventory element 712 during live, dynamic advertising would also be occluded from view by the video game player.

As can be understood, embodiments of the present invention provide a method of generating an analysis or certification of inventory elements in a video game environment. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, causes the one or more computing devices to perform a method of analyzing inventory elements in a video game environment, the method comprising:
referencing data from a video game environment, wherein the data comprises the identity of each of one or more inventory elements in the video game environment;
populating each of the one or more inventory elements with a test pattern, wherein each test pattern corresponds to the identity of each of the one or more inventory elements being populated;
referencing screenshots of each of the one or more inventory elements in the video game environment;
based on the screenshots of each of the one or more inventory elements, identifying features associated with each of the one or more inventory elements; and
based on the identified features associated with each of the one or more inventory elements, automatically generating an analysis of each of the one or more inventory elements in the video game environment.

2. The one or more computer-readable media of claim 1, wherein the identity of each of the one or more inventory elements comprises at least one of a name, a unique identifier, and a location.

3. The one or more computer-readable media of claim 1, wherein referencing screenshots of each of the one or more inventory elements comprises:
receiving a screenshot of each of the one or more inventory elements, wherein each screenshot was acquired by automatically changing a location of a camera to a respective viewpoint of each of the one or more inventory elements in the video game environment; and
editing the screenshot to eliminate content outside a perimeter of the test pattern.

4. The one or more computer-readable media of claim 1, wherein identifying features associated with each of the one or more inventory elements comprises utilizing an optical character recognition (OCR) tool to identify one or more of a name, a unique identifier, a “TOPLEFT” keyword, a “TOPRIGHT” keyword, a “BOTTOMLEFT” keyword, a “BOTTOMRIGHT” keyword, a color indicator, and a shading gradient indicator.

5. The one or more computer-readable media of claim 4, wherein automatically generating an analysis of each of the one or more inventory elements in the video game environment comprises analyzing identified features of each of the one or more inventory elements.

6. The one or more computer-readable media of claim 5, wherein automatically generating an analysis of each of the one or more inventory elements in the video games environment comprises one or more of:
determining whether a unique identifier is present;
deriving a border utilizing the “TOPLEFT” keyword, “TOPRIGHT” keyword, “BOTTOMLEFT” keyword, and “BOTTOMRIGHT” keyword;
determining whether any of the one or more inventory elements are at least partially occluded;
determining whether any of the one or more inventory element are at least partially inverted;
determining whether any of the one or more inventory element are at least partially stretched;
determining whether colors are displayed correctly in any of the one or more inventory elements;
determining whether shading is displayed correctly in any of the one or more inventory elements; and
determining whether any of the one or more inventory elements have “passed” or “failed” the analysis.

7. The one or more computer-readable media of claim 1, wherein the method further comprises:
generating a report of the analysis of each of the one or more inventory elements.

8. The one or more computer-readable media of claim 7, wherein the method further comprises:
presenting the report for viewing by a user.

9. A method performed by one or more server devices for analyzing one or more inventory elements in a video game environment, the method comprising:
receiving an identity and location of each of one or more inventory elements in the video game environment;
populating each of the one or more inventory elements in the video game environment with a test pattern, wherein each test pattern corresponds to the identity and location of each of the one or more inventory elements;
receiving screenshots of each of the one or more inventory elements in the video game environment;
based on the screenshots of each of the one or more inventory elements, identifying features associated with each of the one or more inventory elements; and
based on the identified features associated with each of the one or more inventory elements, automatically generating an analysis of each of the one or more inventory elements in the video game environment.

10. The method of claim 9, wherein the identity of each of the one or more inventory elements comprises one or more of a unique identifier and a name.

11. The method of claim 9, wherein the location of each of the one or more inventory elements comprises the three-dimensional coordinates, in the video game environment, of each of the one or more inventory elements.

12. The method of claim 9, wherein receiving screenshots of each of the one or more inventory elements in the video game environment comprises:
receiving a screenshot of each of the one or more inventory elements, wherein each screenshot was acquired by automatically changing a respective viewpoint of a camera in the video game environment to the location of each of the one or more inventory elements in the video game environment.

13. The method of claim 12, wherein the method further comprises:
editing the screenshot for at least one of the one or more inventory elements to eliminate content outside a perimeter of the test pattern.

14. The method of claim 9, wherein identifying features associated with each of the one or more inventory elements comprises utilizing an optical character recognition (OCR) tool to identify, in the screenshots of each of the one or more inventory elements, one or more features associated with each of the one or more inventory elements.

15. The method of claim 14, wherein identifying features associated with each of the one or more inventory elements comprises identifying one or more of a name, a unique identifier, a “TOPLEFT” keyword, a “TOPRIGHT” keyword, a “BOTTOMLEFT” keyword, a “BOTTOMRIGHT” keyword, a color indicator, and a shading gradient indicator.

16. The method of claim 15, wherein automatically generating an analysis of each of the one or more inventory elements in the video game environment comprises one or more of:
determining whether a unique identifier is present in the screenshot;
deriving a border utilizing the “TOPLEFT” keyword, “TOPRIGHT” keyword, “BOTTOMLEFT” keyword, and “BOTTOMRIGHT” keyword in the screenshot;
determining whether any of the one or more inventory elements are at least partially occluded in its respective screenshot;
determining whether any of the one or more inventory elements are at least partially inverted in its respective screenshot;
determining whether any of the one or more inventory elements are at least partially stretched in its respective screenshot;
determining whether colors are displayed correctly in each screenshot;
determining whether shading is displayed correctly in each screenshot; and
determining whether each of the one or more inventory elements “passed” or “failed” the analysis.

17. The method of claim 9, further comprising generating a report of the analysis of each of the one or more inventory elements.

18. One or more computer-readable media storing computer-useable instructions that, when used by one or more computing devices, causes the one or more computing devices to perform a method for analyzing inventory elements in a three-dimensional video game environment, the method comprising:
referencing an identity and a location of each of one or more inventory elements in the three-dimensional video game environment, wherein an identity of each of the one or more inventory elements comprises at least one of a name and a unique identifier, and further wherein a location of each of the one or more inventory elements comprises three-dimensional coordinates of each of the one or more inventory elements in the video game environment;
populating each of the one or more inventory elements in the video game environment with a respective test pattern, wherein each respective test pattern corresponds to the identity and location of each of the one or more inventory elements;
referencing screenshots of each of the one or more inventory elements in the video game environment, wherein each screenshot was acquired by automatically changing a respective viewpoint of a camera to the location of each of the one or more inventory elements in the video game environment;
editing each respective screenshot to eliminate content outside a perimeter of the test pattern populating each of the one or more inventory elements;
based on the respective screenshot of each of the one or more inventory elements, identifying one or more features associated with each of the one or more inventory elements using an OCR tool, wherein identifying one or more features associated with each of the one or more inventory elements comprises identifying one or more of a name, a unique identifier, a “TOPLEFT” keyword, a “TOPRIGHT” keyword, a “BOTTOMLEFT” keyword, a “BOTTOMRIGHT” keyword, a color indicator, and a shading gradient indicator;
based on the identified one or more features associated with each of the one or more inventory elements, automatically generating an analysis of each of the one or more inventory elements in the video game environment, wherein the analysis comprises one or more of:
(1) determining whether a unique identifier is present;
(2) deriving a border utilizing the “TOPLEFT” keyword, “TOPRIGHT” keyword, “BOTTOMLEFT” keyword, and “BOTTOMRIGHT” keyword;
(3) determining whether any of the one or more inventory elements are at least partially occluded;
(4) determining whether any of the one or more inventory elements are at least partially inverted;
(5) determining whether any of the one or more inventory elements are at least partially stretched;
(6) determining whether colors are displayed correctly in any of the one or more inventory elements;
(7) determining whether shading is displayed correctly in any of the one or more inventory elements; and
determining whether each of the one or more inventory elements “passed” or “failed” the analysis.

19. The one or more computer-readable media of claim 18, wherein identifying one or more features associated with each of the one or more inventory elements using an OCR tool further comprises generating a list of identified features, wherein the list is utilized to automatically generate the analysis.

20. The one or more computer-readable media of claim 18, wherein the method further comprises generating a report of the analysis of each of the one or more inventory elements.
